(19) United States
(12) Patent Application Publication
(10) Pub. No.: US 2016/0179842 A1
(43) Pub. Date: Jun. 23, 2016

(54) Computerized Search Dependant on Spatial States

(71) Applicant: GeoVector Corp., Portland, OR (US)

(72) Inventor: Thomas William Ellenby, San Jose, CA (US)

(73) Assignee: GeoVector Corp.

(21) Appl. No.: 14/580,105

(22) Filed: Dec. 22, 2014

(51) Int. Cl. G06F 17/30; H04L 29/08

(52) U.S. Cl. CPC G06F 17/30241; G06F 17/30061; H04L 67/18

(57) ABSTRACT

Mobile computing platforms equipped with sensors for determining, spatial parameters such as position and pointing direction form basis for advanced search systems whereby a search is conducted in view of an offset to specify preferred fields of interest which lie ahead of a user—for example in a direction of travel. User selectable offsets and prescribed default offsets further aid formation of high performance queries which tend to produce more relevant search results related to a user's most immediate interests.

### CONTINUING INFORMATION

This application is an original non-provisional application which claims benefit from an earlier filed provisional application having Ser. No. 61/964,126 filed Dec. 23, 2013.

### BACKGROUND OF THE INVENTION

1. Field

The following invention disclosure is generally concerned with computer search systems and more specifically concerned with computer search systems based upon parameters of a spatial nature with particular regard to a local environment.

2. Related Systems

Current Location Based Systems (LBS) are well know to the art but all such searches are based upon either the determined location of a device (GPS etc.) or even more simply based upon an entered coordinate (typed latitude-longitude, click on a map, et cetera). In brief, searching and search results use as inputs a measured GPS value. For example, a mobile phone GPS measures a user's position and database queries having a latitude and longitude values as parametric input returns results which are biased according to the location of the user mobile device. By searching based upon a user's location, search results can relate more closely to the presumed interests of a user.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

It should be understood that all of herein referenced materials including those of the provisional application provide considerable definition, with regard to elements of these inventions. Therefore, those materials are incorporated herein by reference whereby this specification can rely upon them far enablement of the particular teachings of each.

### SUMMARY OF THE INVENTION

Comes now, Thomas Ellenby with inventions of computerized search systems which depend on spatial states apparatus and the environments in which they operate including devices and methods. It is a primary function of these computer search systems to provide means by which stored information may be recalled and organized in an efficient manner. It is a contrast to prior art methods and devices that systems first presented here have search results which depend upon the spatial nature and orientation of devices and the environments in which they are used and operated.

The invention includes a mobile device for example a smartphone which operates to measure position and pointing direction. Further, an offset is used to compute reference location which can be used in parametric input to a database search query. Search results returned to the user depend upon the location and orientation of the device and in particular are modified and improved by including an adjustment (position offset) which improves the system focus on a more preferred field of interest.

### OBJECTIVES OF THE INVENTION

It is a primary object of the invention to provide new computerized searching systems.

It is an object of the invention to provide geography dependent search strategies.

It is a further object to provide user :localized search apparatus and systems.

It is an object of the invention to provide search systems having dependence upon. spatial. states of apparatus and particularly apparatus with respect to surrounding environments.

A better understanding can be had with reference to detailed description of preferred embodiments and with reference to appended drawings. Embodiments presented are particular ways to realize the invention and are not inclusive of all ways. possible. Therefore, there may exist embodiments that do not deviate from the spirit and scope of this disclosure as set. forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a diagram which illustrates steps of a representative version of one method of these teachings;

FIGS. 2 and 3 are also a similar diagram illustrating method steps; and

FIGS. 4 through 10 are diagrams having maps illustrated therein with important geometric constructs overlaid thereon.

### DETAILED DESCRIPTION AND PREFERRED EMBODIMENTS

What is disclosed is method and apparatus for accessing information. relating to a remote location by pointing a device from a known or determined location and using a distance offset along that unique vector to define the coordinates of the remote location. The coordinates of the remote location may then used to search a database of geolocated information. Variations and more advanced versions of such a search are also disclosed.

The results of such a search may be text, graphics or audio. Also, the position and pointing direction of the device may be displayed on a map and a cursor may be enabled to roll up and down the vector defined by position and pointing direction of device to enter the position offset and hence define an offset position. The results of such an offset position search could be displayed in real time to the user. The user of such a device could scroll offset distance using thumb wheel, rocker button etc on device. The same method could he used without map by displaying active search results to the user as they scroll in or out and/or change the position and/or pointing direction of device.

The position offset may be a simple distance or may be as variable defined by the current local circumstances. Such a variable may be the length of a city block in the local area, the distance to the nearest object of a specific type such as a bridge or hospital, the distance to a “friend”, etc. The distance offset may also be limited by boundaries, either real or virtual, in the local area. Such a boundary may for example he a river or the fence, real or virtual, to a secure or restricted geographical space or area The system could inform the user of the maximum extent the search is allowed in the direction currently being pointed because of such a limitation, In the case of a river the user of such a device may not be able to cross the obstruction and therefore returning search results located on the other side of the river would he of no use to the user or such a system.

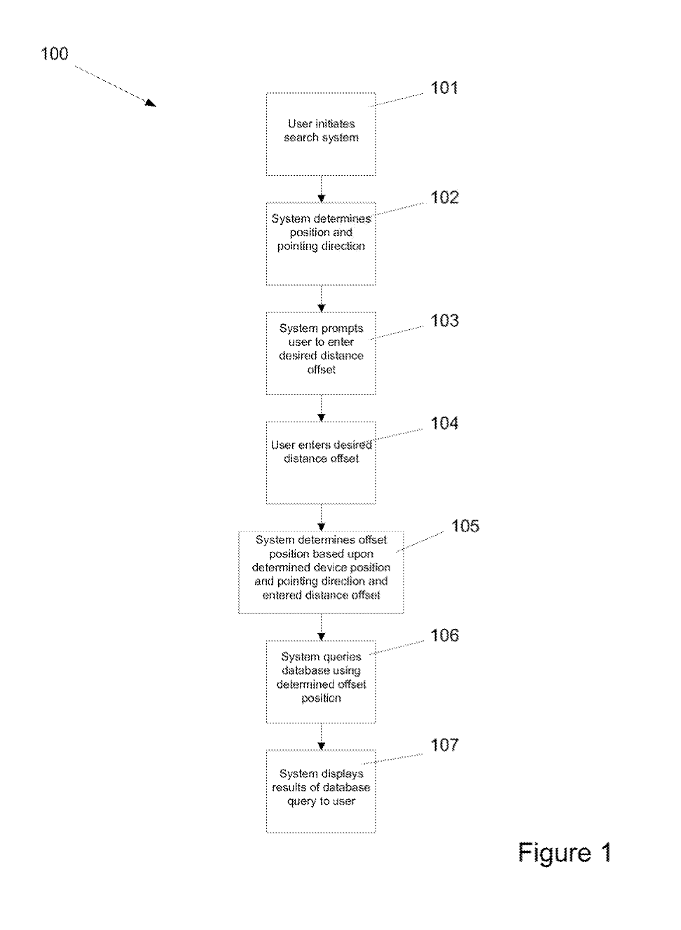

FIG. 1 is a flowchart 100 that shows operation of an example version of these database search systems which depend upon the spatial states and parameters of devices and the environments in which they operate. In a first step, an initialization step 101 the user of the system initiates a search. Searches may be done automatically in response to triggered conditionals or under the influence of direct requests by users of these devices.

The method then proceeds to step 102 as indicated in the flowchart of the diagram. In a position and pointing direction determining step 102, the system determines the device location and/or position and pointing direction and/or orientation. This are done by internal sensors which operate within the device to periodically measure same. For example a GPS receiver and electronic compass can perform these functions.

After position and pointing direction are determined, the method then proceeds to step 103. In step 103 the system prompts a user to choose and enter a desired distance offset. Such offset data may be entered in a variety of ways such as via keypad, voice, touch screen, et cetera. A user expresses this offset distance based upon a field of interest which may begin some distance from where the user operates the device.

The method proceeds to step 104 in which a user input is made. In step 104 the user enters the desired distance offset from which she wishes the search to be based. Because a field of interest may be a considerable distance from a user, it is preferable to eliminate search results for those things which are not within the field of interest.

The method thereafter includes a step in which a location of an offset position is determined based upon the distance specified by the user in the previous step. In step 105, an on-board computing platform calculates the coordinates of a location which lies the specified distance from the user (device) in the direction which the device was determined to be pointing. in step 105 the system determines the offset position based upon the determined position and pointing direction of the device and the user entered distance offset. The method then executes step 106.

In step 106 the system queries a database using, the determined offset position coordinates as parametric inputs. This database may, for example, be a typical GIS type database comprising, information with associated geographic indicators or associations. The method then proceeds to a display results step 107. In step 107 the results of the database query are presented to the user by the system. The results may simply be displayed visually via, text and/or graphics or alternately could be presented in audio form.

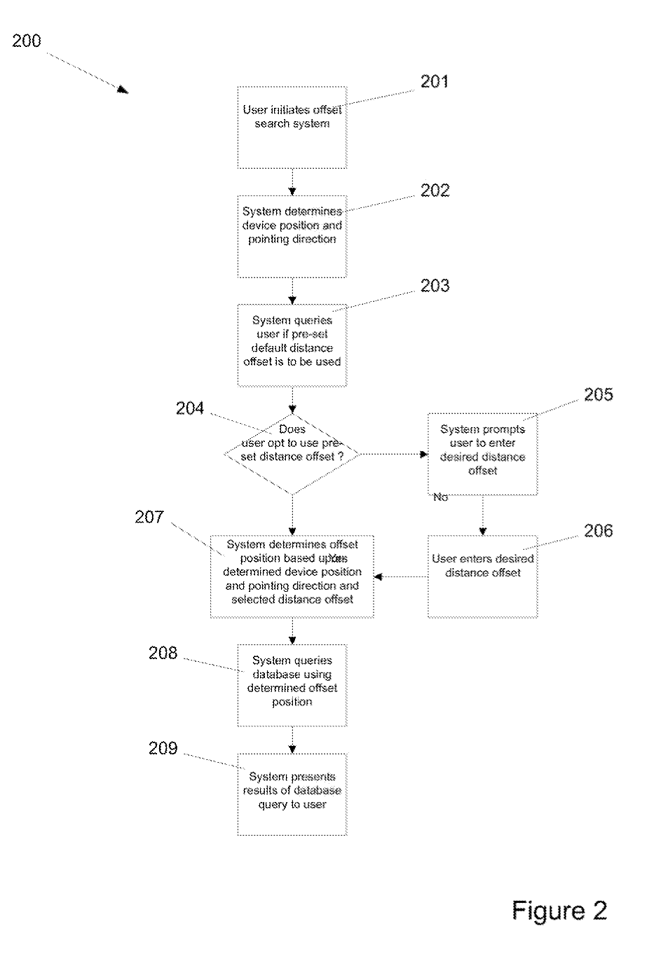

FIG. 2 is a method flowchart 200 diagram that shows operations of alternative advanced versions of the offset search system that includes a default distance offset, for example 10 meters. In step 201 the user of the user of the system initiates a search which depends upon the spatial states of a mobile device and in more particular those states with respect to the environment in which the device is operated. The method then proceeds to step 202.

In step 202 the system determines the device position and pointing direction. Similar to the previous version, these determinations may he made with on-board electronic sensors operated in a loop mode.

After position and pointing direction have been correctly measured, the method then advances to step 203.

In step 203 the system queries the user to see if they would like to use the pre-set default distance offset or specify another distance value, The method steps continue to step 204. In step 204 the system determines if the use has opted to use the pre-set default distance offset. This default distance offset could be user defined or application specific.

If the user has opted to use the default distance offset the flowchart branches to step 207. If the user of the system has not opted to use the default distance offset the flowchart branches to step 205.

In step 205 the system prompts the user to enter a desired offset distance. The method then proceeds to step 206. In step 206 the user enters the desired distance offset. The flowchart then branches to step 207. In step 207 the system determines the offset position based upon the determined position and pointing direction of the device and the selected, i.e. default or user entered, distance offset. The method then goes to step 208. In step 208 the system queries a database using the determined offset position. The flowchart continues to step 209. In step 209 the results of the database query are presented to the user by the system.

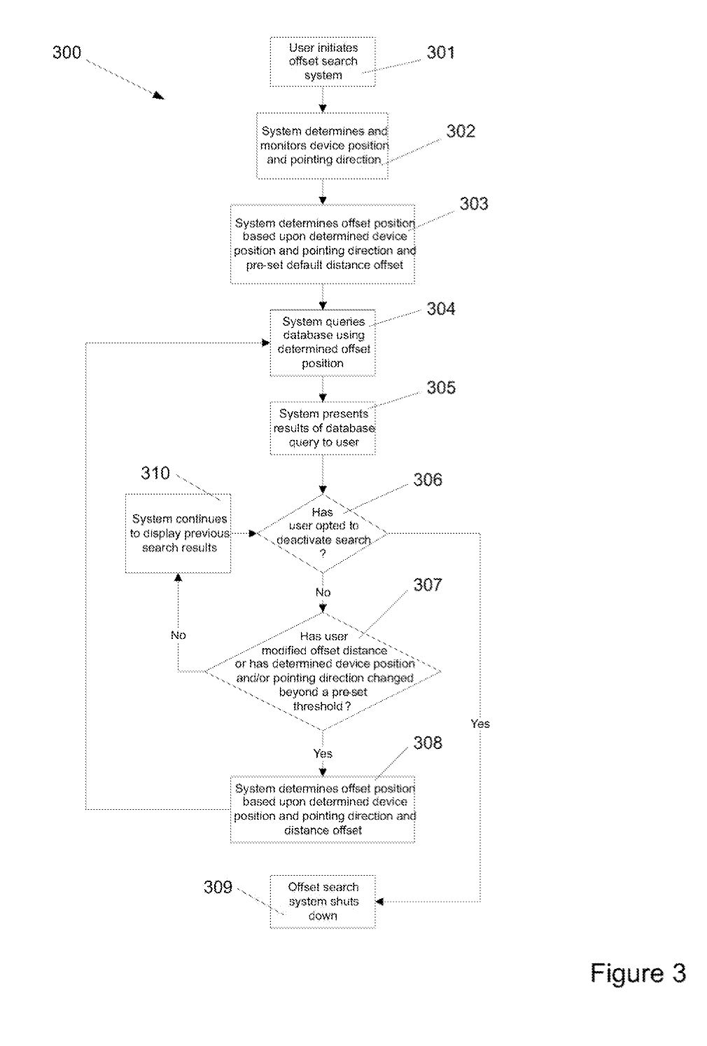

FIG. 3 similarly includes a flow type diagram or flowchart 300 that shows the operation of another alternative advanced version of the offset search system that includes real time updating of the search results as the device position and/or pointing direction and/or the offset distance are changed/modified. In step 301 the user of the user of the system initiates a search and thereafter the method advances to step 302.

In step 302 the system determines position and pointing direction and begins to monitor and remeasure continuously in a loop process the device position and pointing direction. The method continues to step 303. In step 303 the system determines an instantaneous offset position based upon the determined position and pointing direction of the device and the pre-set default distance offset. The flowchart diagram then indicate advance to step 304 In step 304 the system queries a database using the determined offset position.

The method then branches to step 305. In step 305 the results of the database query are presented to the user by the system. The method then branches to step 306. In step 306 the system determines whether the user of the system has opted to deactivate the offset search system. If the user of the system has opted to deactivate the offset search system the flowchart goes to step 309 in which the offset search system is shut down. If the user of the system has not opted to deactivate the offset search system the flowchart branches to step 307.

In step 307 the system determines if the user has modified the offset distance or the monitored position and/or pointing direction of the device have changed beyond a pre-set threshold. The user may modify the offset distance in various ways such as key entry, voice, scroll button or roller, et cetera. By setting a threshold for the change in position or pointing direction the system will able to account for the normal small movements of, for example, a human had holding a device such as a cell phone without having to constantly calculate new search results. If any of the offset distance, device position or device pointing direction, have changed sufficiently the flowchart branches to step 308. If any of the offset distance, device position or device pointing direction have not changed sufficiently the flowchart branches to step 310 in which the system continues to display the current search results and then branches back to step 306.

Hence the system will continue to display the results of the latest search until the offset distance, device position or device pointing direction have changed. In step 308 the system the system determines the new offset position based upon the determined position and pointing direction of the device and the current distance offset. The flowchart then branches to step 304 and presents the results of the modified search to the user.

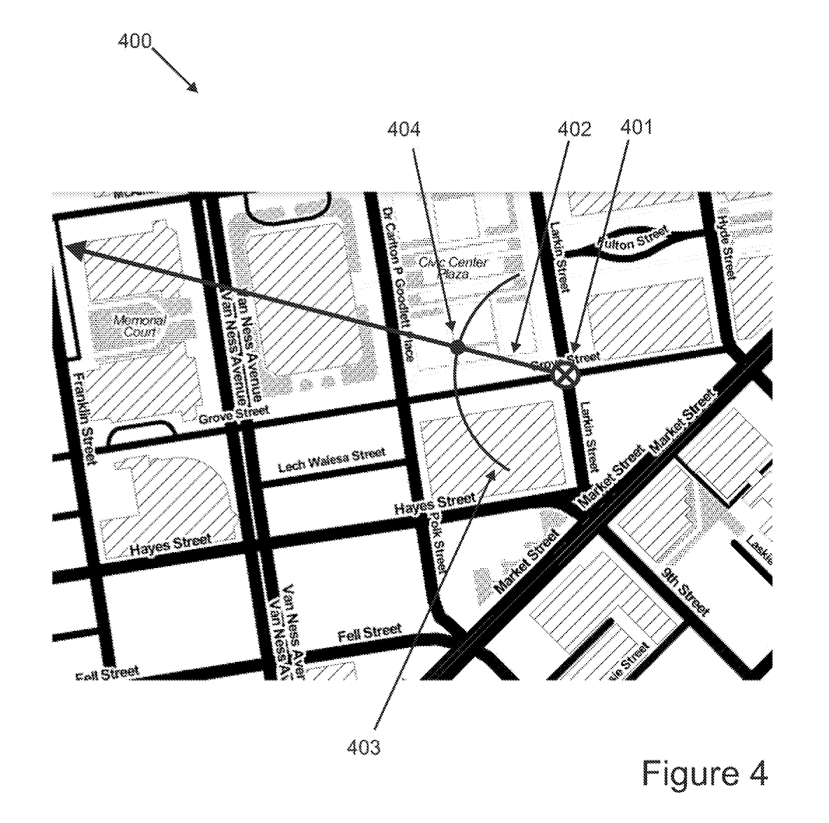

FIGS. 4-6 are map views 400, 500 & 600 illustrating the operation of such a system.

In FIG. 4 a device is at position 401, the cross street of Grove and Larkin in San Francisco at Latitude 37.778651 Longitude −122.416593, pointing in direction 402. A distance offset 403 of 50 m has been entered and the system is able to determine the coordinates of the offset position. 404 as Latitude 37.778876 Longitude −122.417674. By searching a database using the coordinates of the offset position 404 the system returns a. result of “Civic Center Plaza”.

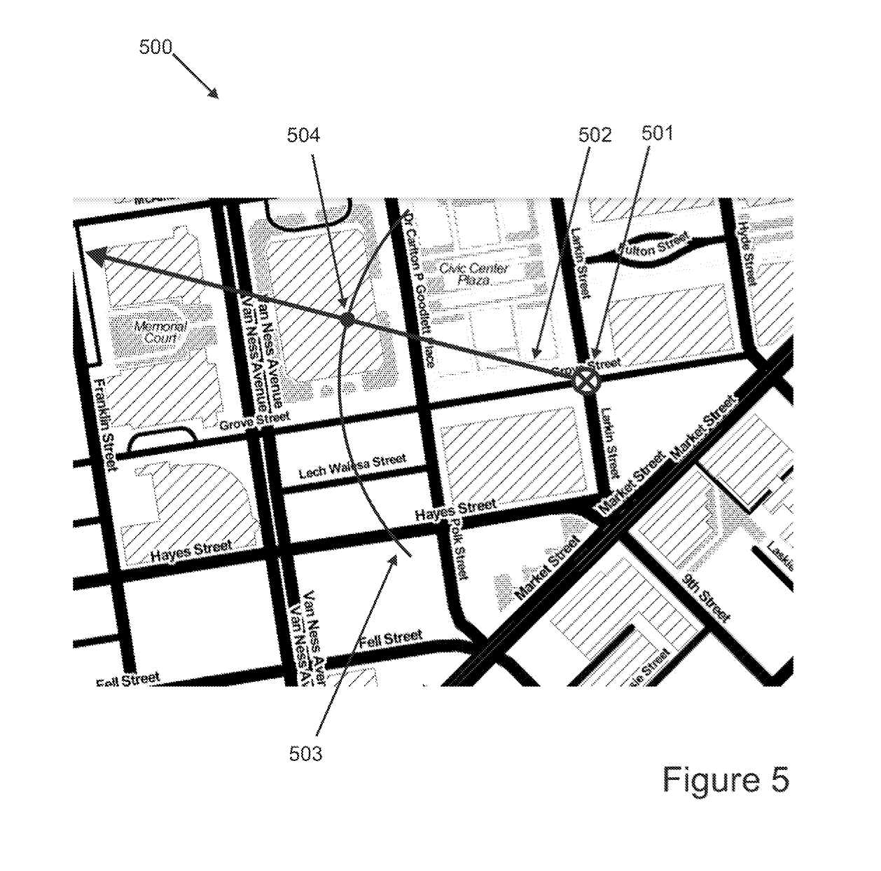

In FIG. 5 the device position 501 and pointing direction 502 are the same as in FIG. 4 but the distance offset 503 has been increased to 100 m. The system is able to determine the coordinates of the offset position 504 as Latitude 37.779211 Longitude −122.418911. By searching a database using the coordinates of the offset position 504 the system returns a result of “San Francisco City Hall”.

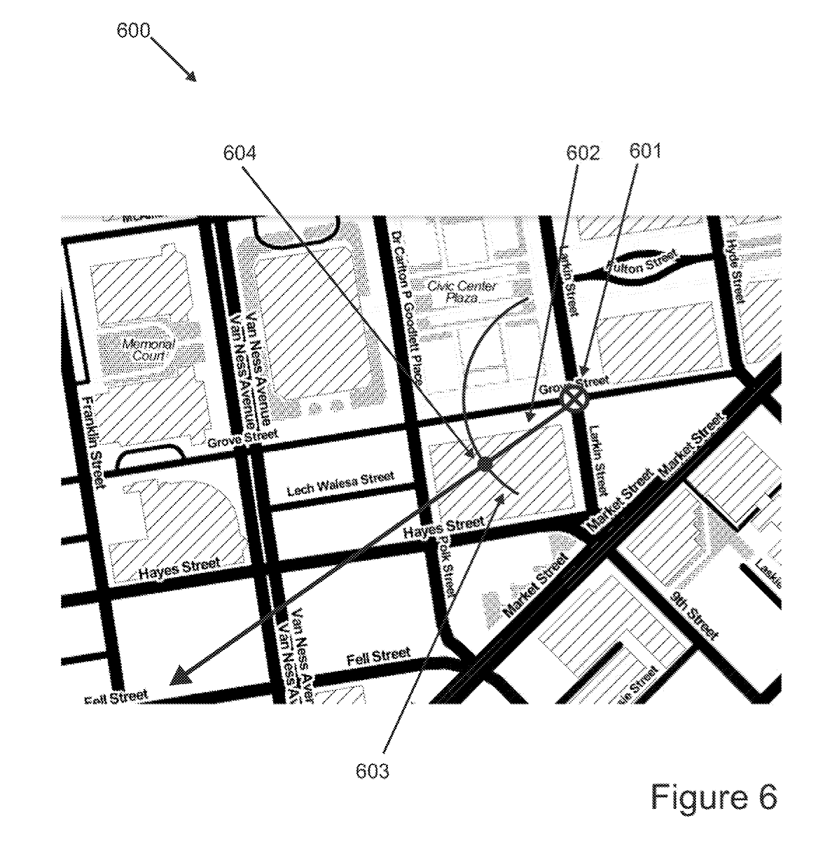

In FIG. 6 the device position 601 and distance offset 603 are the same as in FIG. 4 (Latitude 37.778651 Longitude −122.416593 and 50 m respectively) but the pointing direction 602 has been changed. The system is able to determine the coordinates of the offset position 604 as Latitude 37.778159 Longitude −122.417516. By searching a database using the coordinates of the offset position 604 the system returns a result of “Bill Graham Civic Auditorium”.

These examples illustrate the change of search results based upon modifying the pointing direction and distance offset but it should be appreciated that changing the location of the device will also modify the search results. By using the three parameters of position, pointing direction and distance offset a user of such a system is able to define a location of interest remotely.

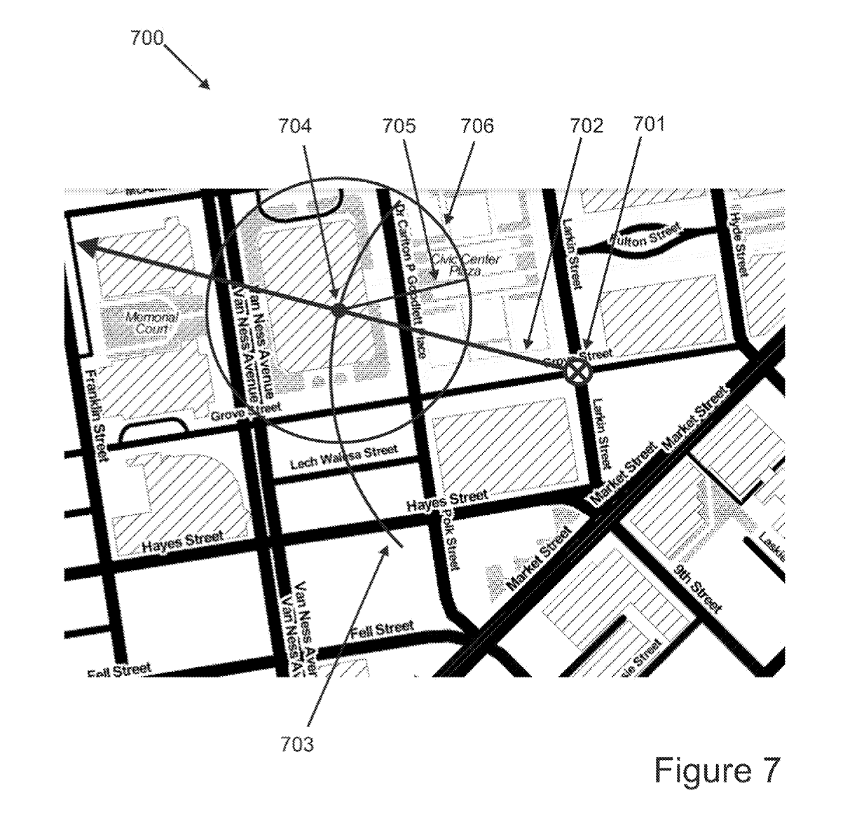

A variation of such a search may be to define the search as within as certain distance of the determined offset position. FIG. 7 is a map view 700 illustrating the operation of such a system. A device is a location 701 pointing in direction 702 with a distance offset 703 of 100 meters. The offset position is determined to be located at the coordinates marked as 704. By also including a search radius 705 of 50 meters the system is able to determine a search area centered on the determined offset position 704 with a. circular perimeter 706. This search radius may be a pre-set default or may be entered by the user of such a system in various ways including keypad, scroll button, voice, et cetera. By searching the database for points of interest within the determined search area the system is able to return results of both the Civic Center Plaza and San Francisco City Hall.

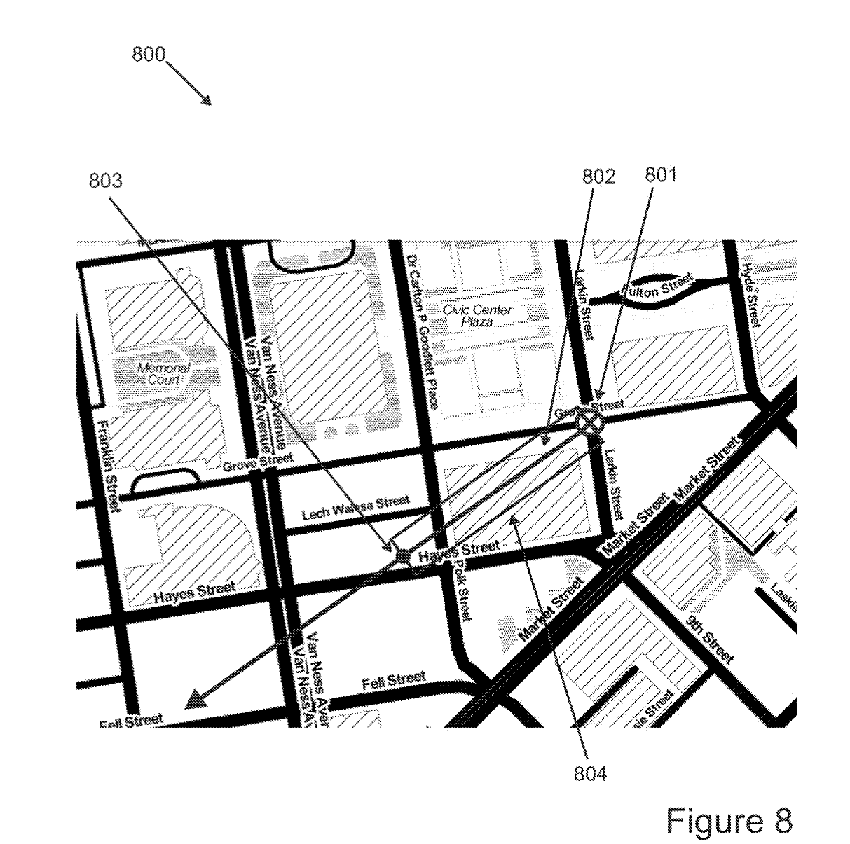

Another variation of such a search may be to define the search as within a geometric shape between the determined location of the device and the determined offset. position. FIG. 8 is a map view 800 illustrating the operation of such a system. A device is a location 801 pointing in direction 802 with a distance offset of 100 meters. The offset position is determined to be located at the coordinates marked as 803. The search area is defined as a rectangle 904 bounded by the determined position of the device and the determined offset position and with a width that may be a default, say 20 meters, or set by the user of the system.

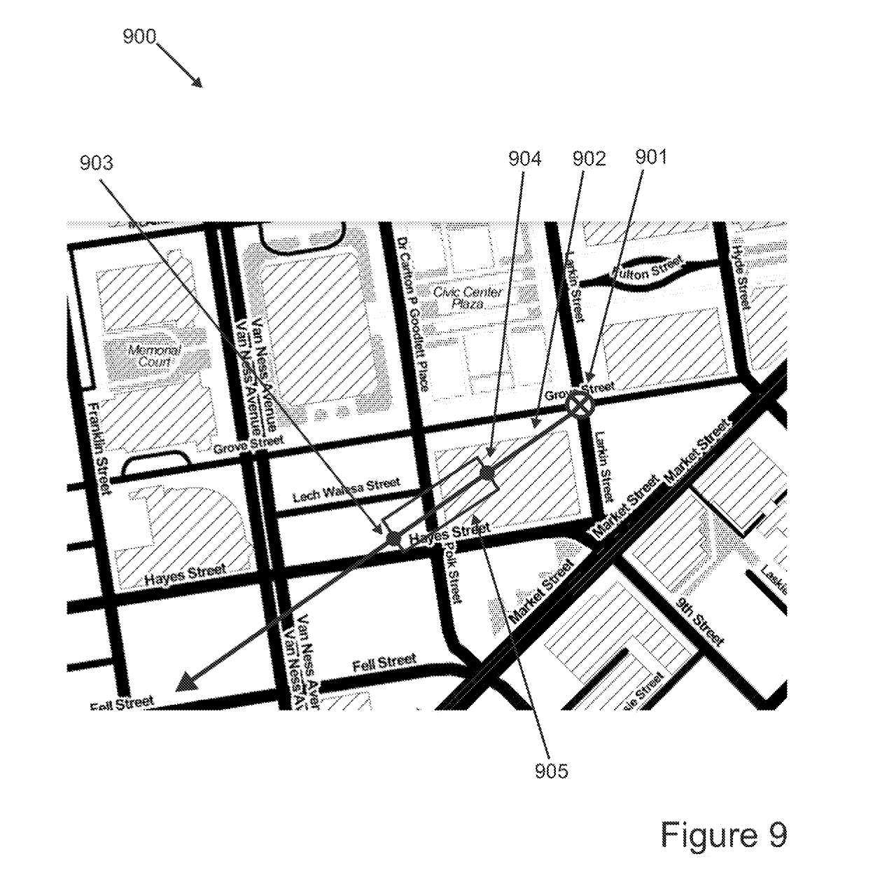

A more advanced version of such a search may be created by using two offset positions. FIG. 9 is a map view 900 illustrating the operation of such a system. A device is a location 901 pointing in direction. 902 with a first distance offset of 100 meters. The first offset position is determined to be located at the coordinates marked as 903. A second distance offset of 50 meters is then used to determine the coordinates second offset position marked as 904. The search area is defined as a rectangle 904 bounded by the first determined offset. position 903 and the second offset position 904 and once again with a width that may be a default, say 20 meters, or set by the use of the system.

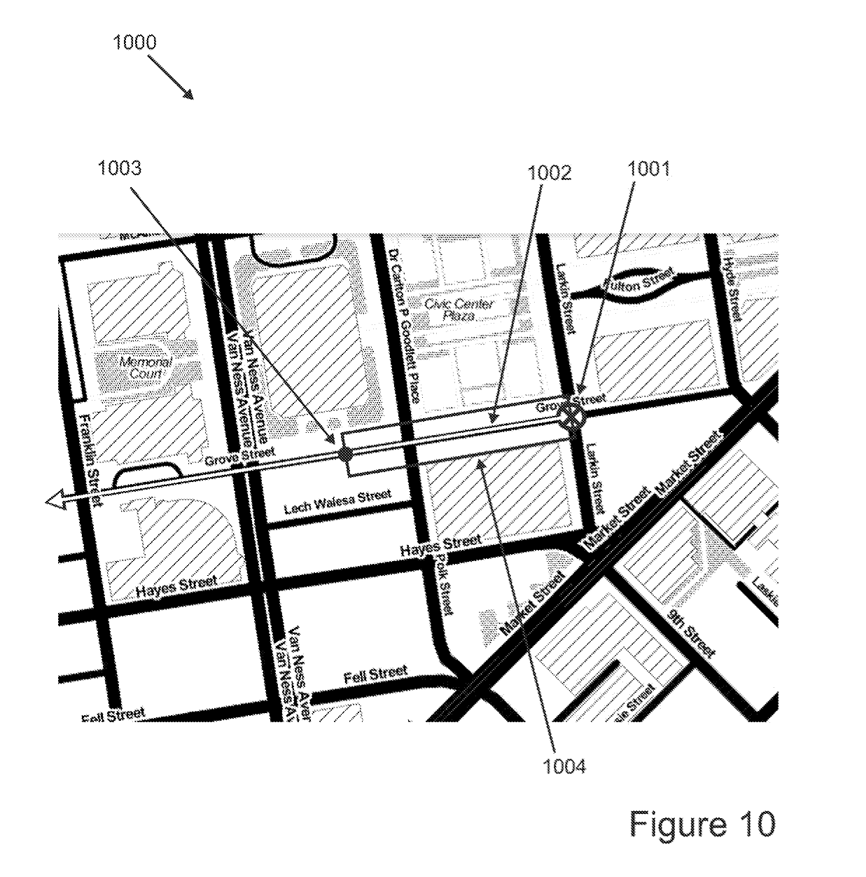

An example of a special use of such a system as illustrated in FIGS. 8 & 9 is if such a system is pointed directly down a street. FIG. 10 is a map view 1000 illustrating the operation of such a system. A device is a location 1001 pointing in direction 1002 with a position offset of 100 meters. The offset position is determined to be located at the coordinates marked as 1003. The search area is defined as a rectangle 1004 bounded by the determined position of the device and the determined offset position and with a width that is the width or some multiple of the width of the street being pointed down. The street width could be known to the device given its knowledge of its position provided, for example, by GPS. in such a case the search results could be displayed so as to differentiate the results from the left and right sides of the street as viewed from the perspective of the system. An example may be simply to have two columns of results with the headings left and right and listing the results of the search in a closest to furthest format. Another option may be to display the results of such a search on a map interface.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how advanced search systems which depend on the spatial states of mobile apparatus and the environments in which they operate may he fully realized to effect, highly efficient search results. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) Methods for searching a database of items having geographical associations comprising the steps;
determining a position of a device;
determining a pointing direction of a device;
determining coordinates of a prescribed offset position relative to said determined position and pointing direction and a distance offset, and
querying a database using the coordinates of the determined offset position as parametric inputs.

2) Methods of claim 1, the distance offset being further defined as a prescribed default distance.

3) Methods of claim 1, the distance offset being further defined as being specified by a user of the device via an input means.
